(19) United States
(12) Patent Application Publication
(10) Pub. No.: US 2007/0042228 A1
(43) Pub. Date: Feb. 22, 2007

(54) MAGNETIC RECORDING MEDIUM AND METHOD OF MANUFACTURING THE SAME

(75) Inventors: Kazuhiro KUSAKAWA, Minami-Alps-City (JP); Shinji SHIRAI, Minami-Alps-City (JP)

Correspondence Address: ROSSI, KIMMS & McDOWELL LLP., P.O. BOX 826, ASHBURN, VA, 20146-0826, US

(73) Assignee: FUJI ELECTRIC HOLDINGS CO., LTD., Kawasaki-ku, Kawasaki (JP)

(21) Appl. No.: 11/466,285

(22) Filed: Aug. 22, 2006

(30) Foreign Application Priority Data
Aug. 22, 2005 (JP) 2005-239901

(51) Int. Cl. G11B 5/65

(52) U.S. Cl. 428/835.6; 427/127; 427/355; 427/372.2

(57) ABSTRACT

A method of manufacturing a magnetic recording medium having a lubrication layer is disclosed. The method includes a step of simultaneously pressing a processing tape including a solvent against the edge face and the peripheral part of the data surface of the magnetic recording medium using a tape pressing device to wipe a liquid lubricant off while rotating the magnetic recording medium, after the liquid lubricant has been applied onto the protective layer. The non-magnetic substrate preferably has a thickness of 0.635 mm or less. The wiping with the processing tape is preferably performed after a heating process that follows the application of the liquid lubricant. The method makes the thickness of a lubrication layer of a magnetic recording medium uniform in a peripheral part thereof to allow a magnetic head to fly with stability.

### CROSS REFERENCE TO RELATED APPLICATIONS

This application is based on, and claims priority to, Japanese Patent Application No. 2005-239901, filed on Aug. 22, 2005, the contents of which are incorporated herein by reference.

### BACKGROUND OF THE INVENTION

A. Field of the Invention

The present invention relates to magnetic recording media such as a magnetic disk loaded in a fixed magnetic disk device used as an external storage device of an information processing apparatus and a method of manufacturing the same. More specifically, the invention relates to a magnetic recording medium having an improved surface shape to allow a magnetic head to fly lower above the magnetic recording medium and a method of manufacturing the same.

B. Description of the Related Art

Fixed magnetic disk devices are widely used as external storage devices for information processing apparatuses such as computers and have recently been put in use as small storage devices in portable telephones and MP3 players.

A magnetic recording medium loaded in such a fixed magnetic disk device is a component for magnetic recording of information. The medium is provided by forming an underlayer, a magnetic recording layer, and a protective layer in order on a substrate, and it is further coated with a liquid lubrication layer. For example, a disk-shaped non-magnetic material such as an aluminum alloy or glass is used as the substrate, and a non-magnetic metal film constituted by a Ni—P film may be formed on a surface of the substrate using an electroless plating process. The non-magnetic substrate is processed to provide a texture on which a non-magnetic metal underlayer made of Cr is formed using a sputtering process to improve magnetic characteristics. Further, a magnetic recording layer made of a Co alloy for recording information is formed using a sputtering process. In order to protect the magnetic recording layer, a hard amorphous carbon protective film known as diamond-like carbon (DLC) that has high lubricating and anti-abrasion properties also is formed using a sputtering process or plasma CVD process, and a liquid lubricant is applied over this. The method of applying the liquid lubrication layer used is frequently an immersion coating process (dipping process) because of its mass-productivity and the simplicity of apparatus. The process is as follows. A substrate is immersed for a certain period of time in a coating liquid obtained by diluting a stock solution of a liquid lubricant with a fluorocarbon type solvent to an appropriate concentration in accordance with the desired film thickness. Thereafter, the solvent is evaporated by lifting up the substrate or lowering the coating liquid at a predetermined speed, and components of the lubricant remaining on the substrate are absorbed onto the protective film at the same time. A spin coating process, spray process, or deposition process may be used as an alternative coating process. Perfluoropolyether (PFPE) is primarily used as the liquid lubrication layer to coat the protective layer.

As a result of the recent increase in the information processing speed of computers, there are demands for a further increase in the recording capacity of magnetic recording media. Since the recording capacity of a magnetic recording medium can be increased by decreasing the flying height of the magnetic head (i.e., the distance between the magnetic head and a surface of the magnetic recording medium), the flying height of heads is becoming smaller and smaller, and the capability of stable flight at a height of 0.4 μm is currently required. When the flying height of a magnetic head decreases, there are more occasions where the magnetic head may come into contact with the magnetic recording medium. Since a lubricant is more likely to transfer and adhere to the magnetic head because of this, the flight of the magnetic head becomes unstable, and this results in significant adverse effects degrading recording and reproduction characteristics and durability of the head.

It has been known that a lubricant is not necessarily applied uniformly in applying a lubrication layer and that the resultant film thickness has a distribution of thick portions. In order to solve this problem, proposals for the leveling of a surface coated with a lubricant have been made, in which a wiper or buff is pressed against the surface to make the distribution of the lubricant uniform (for example, see JP-A-2003-6849 and JP-A-H02-044519). In both of the methods, a part subjected to the wiping process or buffing process is within the data surface of a magnetic recording medium (that is, the head flying region over which the head flies or the recording region). However, as a result of reductions in the flying height of magnetic heads, it has been revealed that the flying characteristics of a head can be adversely affected by local abnormality in the application of a lubricant outside the head flying region. This problem has not been raised in the related art.

FIGS. 9A and 9B are schematic illustrations for explaining a problem with the immersion coating process. The figures are drawn in an exaggerated fashion for easier understanding. According to the immersion coating method, a coating liquid is made to flow down a surface to be coated using gravity. Therefore, a collected drop 21 of a coating liquid is formed at the lower peripheral part of magnetic recording medium 20 as shown in FIG. 9A, and lubricant residue 22 will remain on an edge face at the periphery of the magnetic recording medium as shown in FIG. 9B after the solvent is evaporated. The edge face of the magnetic recording medium is outside the flying region of the magnetic head and does not directly face the magnetic head. However, it has been revealed that such a residual lubricant spreads on the surface of the magnetic recording medium as time passes to give adverse effects on the flight of the magnetic head. The generation of a residual lubricant on an edge face is not specific to the immersion coating method. In the case of the spin coating method, a centrifugal force used for coating acts similarly to gravity to cause a similar phenomenon.

In order to avoid this phenomenon, it has been proposed to remove a lubricant by pressing a wiping tape against the edge face (see JP-A-2004-326880, for example). However, studies made by the inventors have revealed that the method simply involving the application of a wiping tape to an edge face will result in a new problem as the thickness of substrates used for magnetic recording media becomes smaller. Specifically, the amount of a lubricant or coating liquid that flows down to an edge face of a magnetic recording medium substantially depends on the surface area of the magnetic recording medium, not the thickness of the medium. However, the smaller the thickness of the magnetic recording medium, the smaller the area of the edge face of the magnetic recording medium becomes. Therefore, the amount of the coating liquid that flows down per unit area of the edge face increases. As a result, the lubricant, which would have remained on the edge face in the past, can remain even on the main surface of the magnetic recording medium in the vicinity of the edge face of the magnetic recording medium. In the case of magnetic recording media whose substrates are especially thin, a collected drop of lubricant is observed in a peripheral part of a data surface immediately after the lubricant is applied. When a magnetic head comes into contact with the collected drop of lubricant, the lubricant transfers and adheres to the magnetic head, which can make the flight of the magnetic head unstable and have adverse effects on recording and reproduction characteristics and head seek durability.

The present invention is directed to overcoming or at least reducing the effects of one or more of the problems set forth above.

### SUMMARY OF THE INVENTION

The invention was made taking the above-described problem into consideration, and it provides a method of manufacturing a magnetic recording medium having a non-magnetic substrate, a magnetic recording layer, a protective layer, and a lubrication layer, characterized in that a processing tape including a solvent is simultaneously pressed against the edge face of the magnetic recording medium and a peripheral part of a data surface to wipe a liquid lubricant off while rotating the magnetic recording medium after applying the liquid lubricant onto the protective layer.

The thickness of the non-magnetic substrate is preferably 0.635 mm or less.

The wiping with the processing tape is preferably performed after a heating process that follows the application of the liquid lubricant.

The load of the processing tape is preferably between 15 g and 40 g.

The pressing pressure of the processing tape is preferably maintained while the processing tape is pulled away from the magnetic recording medium after wiping off the liquid lubricant.

A magnetic recording medium according to the invention is characterized in that it is manufactured using any of the above-described manufacturing methods.

According to the invention, the accumulation of a lubricant on the edge face of a magnetic recording medium and in an outermost part of a data surface of the magnetic recording medium can be effectively reduced. It is therefore possible to suppress the transfer and adhesion of the lubricant to a magnetic head and to form a magnetic disk surface which allows even a low-flying magnetic head to fly with stability.

### BRIEF DESCRIPTION OF THE DRAWINGS

The foregoing advantages and features of the invention will become apparent upon reference to the following detailed description and the accompanying drawings, of which:

FIG. 1 is a schematic illustration showing an example of a method of a process of wiping a peripheral part of a magnetic recording medium according to the invention;

FIGS. 2A, 2B, and 2C are schematic illustrations showing an example of a configuration of a tape pressing device and an exampling of an pressing method;

FIG. 3 is a schematic illustration showing an example of a configuration of a guide roller according to the invention;

FIG. 4 is a schematic illustration showing a method of a wiping process in Comparative Example 2 which is compared to the invention;

FIG. 5 is a schematic sectional view showing an example of a configuration of the magnetic recording medium according to the invention;

FIG. 6 is a schematic sectional view for explaining a peripheral part of the magnetic recording medium according to the invention;

FIG. 7 is a graph showing thickness distribution in peripheral parts of magnetic recording media in Embodiment 1 and Comparative Example 1;

FIG. 8 is a graph showing thickness distributions in peripheral parts of magnetic recording media in Embodiment 1 and Comparative Example 2; and

FIGS. 9A and 9B are schematic illustrations for explaining a collected drop of lubricant on a magnetic recording medium.

### DETAILED DESCRIPTION OF SPECIFIC EMBODIMENTS

A mode for carrying out the invention will now be described in detail with reference to the drawings.

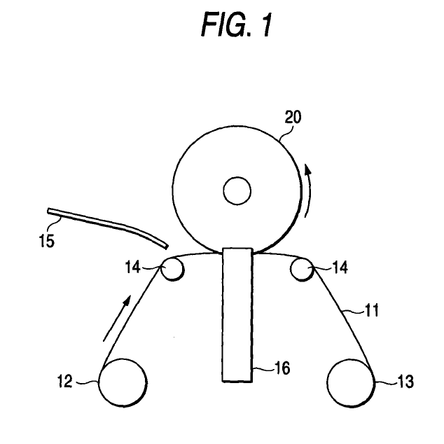

FIG. 1 explains a mode for carrying out the invention, and it is a schematic illustration of a mechanism for wiping an edge face of magnetic recording medium 20 having a lubrication layer formed thereon and for wiping a peripheral part of a data surface of the medium. FIG. 6 is an enlarged schematic illustration of an end of the magnetic recording medium 20, in which edge face 25 and a peripheral part of a data surface 26 are regions to be processed.

Processing tape 11 doped with a solvent is pressed against magnetic recording medium 20 with tape pressing device 16 while rotating the magnetic recording medium, which is coated with a liquid lubrication layer, in the direction of the arrow at 1000 to 3000 RPM. Processing tape 11 is supplied from supply reel 12 and delivered in the direction of the arrow shown near the processing tape. A solvent of the lubricant is supplied from solvent supply nozzle 15, and processing tape 11 is impregnated with the solvent and is thereafter pressed against the magnetic recording medium to perform a wiping process. The tape is collected by take-up reel 13 after the process. A nylon polyester fabric is preferably used as the processing tape, because this material is impregnable with the solvent used but not soluble in the same, and is less susceptible to contamination with particles and the like. Although there is no particular requirement on the solvent to be used as long as it has the function of dissolving the lubricant, isopropyl alcohol or perfluoro carbon is preferred. They have adequate dissolvability against the lubricant. The amount of the solvent dispensed from solvent supply nozzle 15 is preferably 0.01 to 0.10 ml/min.

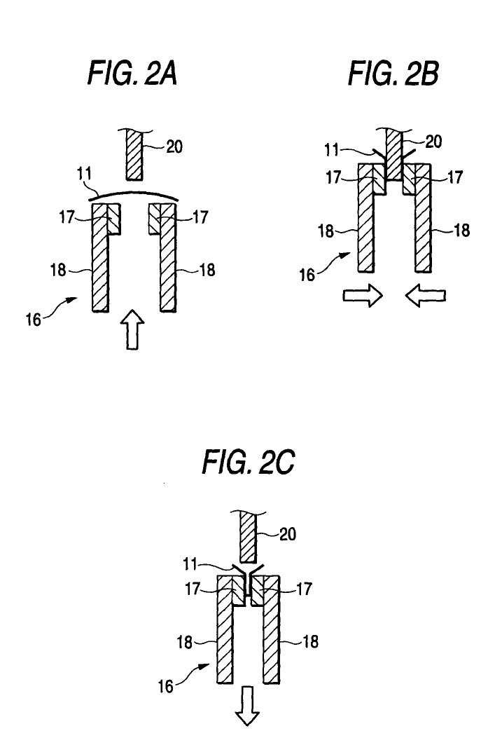

FIGS. 2A to 2C are enlarged schematic illustrations of the region of contact between tape pressing device 16 and magnetic recording medium 20. FIG. 2A shows a state after the magnetic recoding medium is mounted and before the wiping process is performed. FIG. 2B shows a state during the process. FIG. 2C shows a state after the process. Tape pressing device 16 includes pads 17 and pad holding tool 18, and pad holding tool 18 can be opened and closed along the direction of sandwiching the magnetic recording medium. The arrows indicate the moving directions of pad holding tool 18.

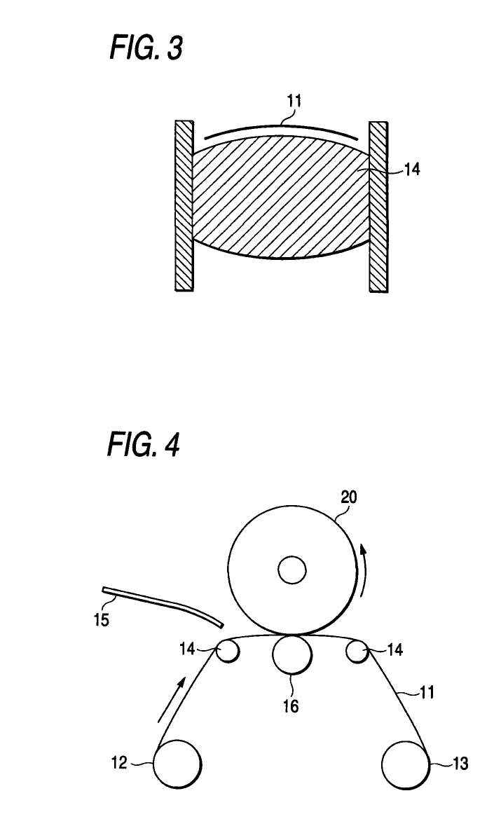

FIG. 2A shows a state immediately before tape pressing device 16 is pressed against the magnetic recording medium, in which pad holding tool 18 is in an open state. The term “open state” means that pads 17 and processing tape 11 to be sandwiched between them are set with such a gap that they will not come into contact with a data surface of the magnetic recording medium when tape pressing device 16 is moved toward the magnetic recording medium. Processing tape 11 is preferably held in an arcuate shape (or a mountain-like shape) as illustrated. FIG. 3 explains an example of a method of holding the processing tape in an arcuate shape. Barrel-shaped rollers having convexity in the middle thereof are used as guide rollers 14, and an adequate tension can be applied to the processing tape between two guide rollers 14 to maintain the arcuate shape. With such an arrangement, edges of the tape can be prevented from touching the surface of the magnetic recording medium during the process, and it is therefore possible to prevent unwanted scratches or generation of particles during the process.

During the process, pad holding tool 18 is closed to press processing tape 11, which has been wetted by being impregnated with the solvent, against the magnetic recording medium at a desired surface pressure with pads 17. At this time, edge face 25 and the peripheral part of the data surface 26 are processed with processing tape 11 that is now in a C-like shape as shown in FIG. 2B. A method of processing the data surface and the edge face separately will result in an increase in the processing time. The simultaneous processing is advantageous also from the viewpoint of cost when the number of processing devices and the amount of the tape used are considered. Pads 17 are preferably pressed with a load of 15 to 40 g in a direction perpendicular to the magnetic recording medium. The reason is that the wiping effect is lost when the load is too small and that an excessively heavy load results in an increase in the frictional force between the tape and the magnetic recording medium and consequently generates dust from the tape.

When the wiping process is finished, tape pressing device 16 is pulled away from the magnetic recording medium as shown in FIG. 2C with pad holding tool 18 kept in the closed state or with the tape kept in the C-like shape to keep the processing tape pressing pressure applied. The purpose is to prevent the lubricant from remaining on the magnetic recording medium after being wiped.

There is no particular limitation on the configuration of the magnetic recording medium according to the invention and the material and forming conditions of each of the layers. Customary techniques in this technical field may be used, differing only in that the liquid lubrication layer is processed through the steps as described above.

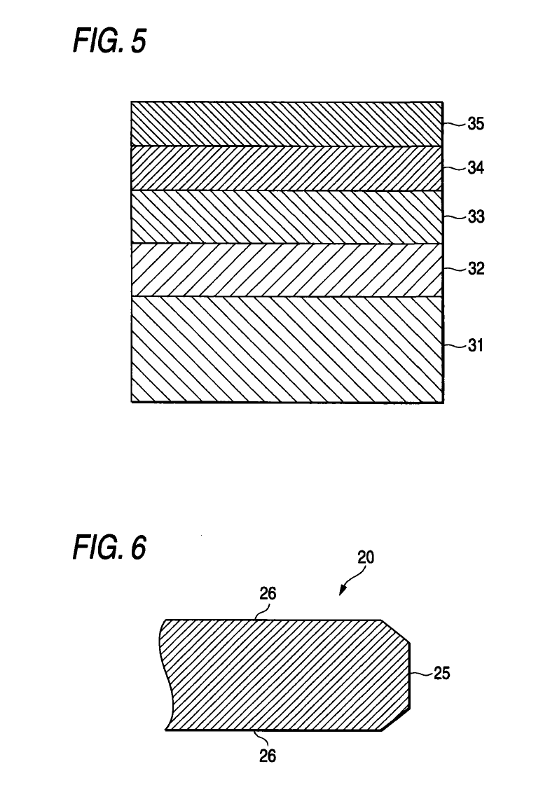

FIG. 5 is a schematic sectional view showing an example of a configuration of the magnetic recording medium. Underlayer 32 is formed on non-magnetic substrate 31. Magnetic recording layer 33 and protective layer 34 are then formed on the same in the order listed using the sputtering method or CVD method, and lubrication layer 35 is thereafter applied using, for example, the immersion coating method. Additional layers such as an alignment control layer, an intermediate layer, and a soft magnetic backing layer may be provided as occasion demands.

Non-magnetic substrate 31 may be a substrate made of a material such as an aluminum alloy, chemically strengthened glass, crystallized glass, ceramic, silicon, polycarbonate, or polymeric resin, and there is no particular limitation on the same. Although there is no particular limitation on the size of the substrate, the invention is advantageous especially when applied to a magnetic recording medium having a diameter in the range from 0.85 in. to 2.5 in. and a thickness of about 0.635 mm or less.

Underlayer 32 may be formed from any customary compound, and there is no particular limitation on the same. For example, Cr, Cr—W, Cr—V, Cr—Mo, Cr—Si, Ni—Al, Co—Cr, Mo, W, or Pt may be used. The layer preferably has a thickness of 20 nm or less. More preferably, it has a thickness in the range from 10 to 20 nm.

Any customary magnetic material may be used for magnetic recording layer 33. For example, it is possible to use a magnetic recording layer composed of CoCrTaPt, CoCrTaPt—Cr₂O₃, CoCrTaPt—SiO₂, CoCrTaPt-ZrO₂, CoCrTaPt-TiO₂, or CoCrTaPt—Al₂O₃. The layer preferably has a thickness of 20 nm or less. More preferably, it has a thickness in the range from 10 to 20 nm. A plurality of magnetic recording layers may be used to provide a recording layer having a multi-layer structure.

Protective layer 34 has the function of protecting the magnetic recording layer against shock from a magnetic head and corrosion attributable to external corrosive substances. For example, amorphous carbon, diamond-like carbon, or nitrogen-doped amorphous carbon may be used. The protective layer preferably has a thickness of 5.0 nm or less. More preferably, it has a thickness in the range from 2.0 to 4.0 nm.

Perfluoropolyether is preferably used as the lubricant forming lubrication layer 35. For example, Z-dol, Z-tetraol, Z-dolTX, an AM type material, or a phosphazene type material may be used. A lubricant that is a mixture of two or more types of materials may be used if desired. The layer preferably has a thickness of 2.0 nm or less. More preferably, it has a thickness in the range from 1.0 to 1.5 nm.

More detailed description will be made with reference to an embodiment of the invention.

### Embodiment 1

A description will now be made on an example of a wiping process that was performed on an edge of a magnetic recording medium in which Z-tetraol was used as a lubrication layer and which had a configuration as shown in FIG. 5.

A glass substrate having an outer diameter of 2.5 in. and a thickness of 0.635 mm was used as non-magnetic substrate 31. The substrate was put in a sputtering apparatus after being carefully washed, and a Cr-type laminated underlayer 32 was formed on the same to a total thickness of 25 nm. Subsequently, a Co-type magnetic recording layer 33 was formed with a thickness of 15 nm, and a nitrogen-doped carbon protective layer 34 was then formed with a thickness of 4 nm. The substrate was thereafter taken out of the sputtering apparatus, and lubrication layer 35 was formed on the same using the immersion coating method. Z-tetraol which was diluted with a fluorine carbon type solvent to 0.03 wt % was used as the lubricant and it was formed into a film at a drawing speed of 1.0 mm/sec. The lubrication layer was applied to a thickness of 1.2 nm as measured at an intermediate annular region of the substrate. Subsequently, a wiping process was performed on an edge of the substrate after heating it for 35 minutes at 70° C.

The edge wiping apparatus used was an apparatus fabricated by the applicant for use within the applicant's company as shown in FIG. 1. NC-310 manufactured by Kanebo, Ltd. was used as processing tape 11. Isopropyl alcohol was used as the solvent. Neoprene rubber having a thickness of 1.5 mm and a width of 5 mm were used as pads 17. Edge processing was performed for three seconds while rotating the substrate at a speed of 2000 rpm and pressing the pads with a load of 20 g in a direction perpendicular to the substrate. To the amount of movement of tape pressing device 16 from the position before the process to the processing position, there was a further 5 mm movement inward from the periphery of the magnetic recording medium after the processing tape contacted the peripheral edge. The moving speed of tape pressing device 16 at this time was 1.0 mm/sec.

### Comparative Example 1

Comparative Example 1 was provided by fabricating a magnetic recording medium similarly to that in Embodiment 1 except that the edge wiping process was not performed.

### Comparative Example 2

A magnetic recording medium was fabricated similarly to that in Embodiment 1 except that a cylindrical roller as shown in FIG. 4 was used as processing tape pressing device 16 of the edge wiping apparatus.

Thickness distributions of lubrication layers were measured using these samples. The measurement was carried out using OSA 5100 manufactured by Candela Corp. An OSA is an apparatus which obliquely irradiates a surface of a magnetic recording medium with P-polarized waves (longitudinal waves) and an S-polarized wave (transverse wave) laser beams and detects the phase difference between reflected beams, thereby quantifying the substance (e.g., carbon or lubricant) on a reflective substance (e.g., a magnetic recording layer or protective layer). In this case, in order to detect the state of the lubrication layers in detail, changes in a phase difference between a Q-polarized wave and an S-polarized wave were used to obtain sensitivity higher than that achievable with only P- and S-polarized waves.

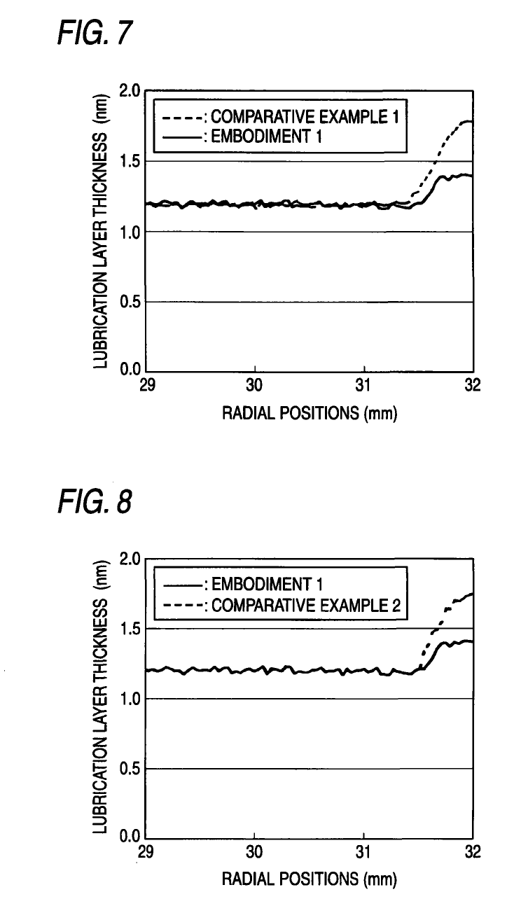

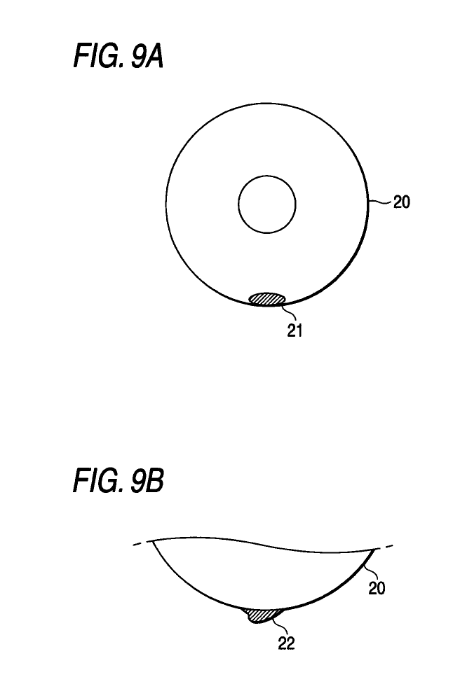

FIG. 7 shows thickness distribution of the lubrication layers of the magnetic recording media in Embodiment 1 and Comparative Example 1. The figure shows values measured in radial positions of the substrate surfaces including locations at the periphery of the substrate where a collected drop of lubricant existed before the edge wiping process was performed. The radial positions represent distances from the center of the magnetic recording media. FIG. 7 shows differences in the thicknesses of the lubrication layers between regions at the periphery of the magnetic recording media where the lubrication layers have greater thicknesses and locations at inner circumferential regions of the magnetic recording media. The thick portion of Comparative Example 1 which had not received the wiping process was about 0.6 nm thicker, whereas the thick portion of Embodiment 1 which had received the wiping process was only about 0.2 nm thicker. It is clear that the height of the collected drop of lubricant at the periphery of the magnetic recording medium was reduced by the wiping process.

FIG. 8 shows thickness distributions of the lubrication layers of the magnetic recording media in Embodiment 1 and Comparative Example 2 measured in the same positions as in FIG. 7. By comparing thickness differences in a way similar to that conducted on FIG. 7, the thick portion of Comparative Example 2 employing tape pressing device 16 in the form of a roller was about 0.5 nm thicker and it is clear that that Embodiment 1 reduced a bank of the lubricant more effectively.

As described above, the height of a bank of lubricant at the periphery of a magnetic recording medium can be reduced by performing a wiping process on the periphery of the magnetic recording medium in an active manner. Thus, the transfer and adhesion of the lubricant to a magnetic head can be reduced to form a surface of the magnetic recording medium over which even a low-flying head can fly with stability.

Thus, a magnetic recording medium and method of manufacturing the same has been described according to the present invention. Many modifications and variations may be made to the techniques and structures described and illustrated herein without departing from the spirit and scope of the invention. Accordingly, it should be understood that the methods and apparatus described herein are illustrative only and are not limiting upon the scope of the invention.

What is claimed is:

1. A method of manufacturing a magnetic recording medium having a non-magnetic substrate, a magnetic recording layer, a protective layer, and a lubrication layer, comprising:
applying a liquid lubricant onto the protective layer, and then
pressing a processing tape including a solvent simultaneously against an edge face and a peripheral part of a data surface of the magnetic recording medium to wipe the liquid lubricant off while rotating the magnetic recording medium.

2. A method of manufacturing a magnetic recording medium according to claim 1, wherein the thickness of the non-magnetic substrate is 0.635 mm or less.

3. A method of manufacturing a magnetic recording medium according to claim 1, wherein the wiping with the processing tape is performed after a heating process that follows the application of the liquid lubricant.

4. A method of manufacturing a magnetic recording medium according to claim 2, wherein the wiping with the processing tape is performed after a heating process that follows the application of the liquid lubricant.

5. A method of manufacturing a magnetic recording medium according to claim 1, wherein the load of the processing tape is between 15 g and 40 g.

6. A method of manufacturing a magnetic recording medium according to claim 2, wherein the load of the processing tape is between 15 g and 40 g.

7. A method of manufacturing a magnetic recording medium according to claim 3, wherein the load of the processing tape is between 15 g and 40 g.

8. A method of manufacturing a magnetic recording medium according to claim 1, wherein the pressing pressure of the processing tape is maintained while the processing tape is pulled away from the magnetic recording medium after wiping off the liquid lubricant.

9. A method of manufacturing a magnetic recording medium according to claim 2, wherein the pressing pressure of the processing tape is maintained while the processing tape is pulled away from the magnetic recording medium after wiping off the liquid lubricant.

10. A method of manufacturing a magnetic recording medium according to claim 3, wherein the pressing pressure of the processing tape is maintained while the processing tape is pulled away from the magnetic recording medium after wiping off the liquid lubricant.

11. A magnetic recording medium having, in order, a non-magnetic substrate, a magnetic recording layer, a protective layer, and a lubrication layer, wherein a processing tape including a solvent has been simultaneously pressed against an edge face and a peripheral part of a data surface of the magnetic recording medium to wipe the liquid lubricant off while rotating the magnetic recording medium.

12. A magnetic recording medium according to claim 11, wherein the thickness of the non-magnetic substrate is 0.635 mm or less.
